(19) United States
(12) Patent Application Publication
(10) Pub. No.: US 2002/0089102 A1
(43) Pub. Date: Jul. 11, 2002

(54) Hydraulic spring

(76) Inventor: Volker Gedenk, Hemmingen (DE)

Correspondence Address: Walter Ottesen, Patent Attorney, P.O. Box 4026, Gaithersburg, MD, 20885-4026, US

(21) Appl. No.: 10/023,668

(22) Filed: Dec. 21, 2001

(30) Foreign Application Priority Data
Dec. 22, 2000 (DE) 100 64 769.3

(51) Int. Cl. F16F 5/00

(52) U.S. Cl. 267/140.13

(57) ABSTRACT

A hydraulic spring has a hydraulic volume (4a, 4b), which is, on the one hand, closed off by spring element (6) which is vulcanized into an outer ring (8) and, on the other hand, the volume (4a, 4b) is delimited by a compensating membrane (10). The tightness between compensating membrane (10) and outer ring (8) is improved by tightly clamping the compensating membrane (10) between the outer ring (8) and the cover (12). The mutually adjacent sealing surfaces (14, 16) of the outer ring (8) and the cover (12), respectively, are configured to be planar. The outer edge (18) of the compensating membrane (10) includes a thickening (22) which fills out a ring-shaped slot (24) of the same radius. The slot (24) is formed in the other ring (8).

### FIELD OF THE INVENTION

The invention relates to a hydraulic spring, especially as a primary spring for use in rail vehicles.

### BACKGROUND OF THE INVENTION

The above-identified hydraulic spring is disclosed in German patent 4,446,800 wherein the spring is referred to as a “hydraulically damping elastic bearing”. The bearing, which is described in German patent 4,446,800 with respect to FIG. 1a thereof, includes a spring element 1 which, on the one hand, is connected to a connecting part 11 and, on the other hand, is fixedly connected to a cylindrical housing 3. The spring element 1 is especially vulcanized to the cylindrical housing 3. The cylindrical housing 3 is secured with threaded fasteners to the other connecting part 12. The cup-shaped bearing cover 13 is connected as one piece to the connecting part 12 and has air compensating bores 13.1. The hydraulic damping system of the bearing comprises the work chamber 6 and the compensating chamber 7 closed off to the ambient by the highly flexible elastic compensating membrane 2 as well as a connecting channel 4 formed in the partition wall 5. The enclosed hydraulic liquid can flow throttled back and forth through the connecting channel 4 between the two chambers.

At the outer edge of the compensating membrane 2, three different parts abut against each other, namely, housing 3, partition wall 5 and bearing cover 13. These three parts must be manufactured with the greatest precision especially at the mutually adjacent surfaces in order to ensure adequate tightness between the work chamber 6 and the compensating chamber 7, on the one hand, and the ambient, on the other hand.

### SUMMARY OF THE INVENTION

Practical experience obtained with continuous operation has shown that the tightness requires improvement. Accordingly, it is an object of the invention to provide a hydraulic spring wherein this improved tightness is provided.

The hydraulic spring of the invention includes: a rubber elastic spring element; a highly flexible elastic compensating membrane; the rubber elastic spring element and the compensating membrane conjointly closing off a volume; a partition wall partitioning the volume into a work chamber delimited by the spring element and a compensating chamber delimited by the elastic compensating membrane; the chambers being changeable in volume and filled with hydraulic fluid; the partition wall having at least one connecting channel to permit a flow of the hydraulic fluid between the chambers during the operation of the hydraulic spring; an outer ring vulcanized to the spring element; and, a cover disposed atop the compensating membrane for pressure tightly attaching the compensating membrane to the outer ring.

With the hydraulic spring of the invention, especially possible leaks in the region of the membrane edge are reliably avoided.

In addition to the improved tightness, the advantages of the invention include a simpler assembly and the allowance of greater tolerances.

The compensating membrane is reliably tightly clamped in a simple manner between the outer ring and the cover. Preferably, the mutually adjacent surfaces of the outer ring and the cover are configured to be planar. In the case of greater tolerances, the sealing surfaces can be slightly after-treated.

A further embodiment of the hydraulic spring of the invention provides that the sealing surface of the outer ring is provided with a circular slot and the compensating membrane is provided with an edge thickening adapted to this slot. In this way, the adjustment during assembly is facilitated and the hold in the clamped state is improved.

It is also conceivable to configure at least one edge thickening of the membrane so that it comes to rest outside and/or within the clamping region. A configuration of this kind also increases the stable position and the hold of the membrane.

Finally, a ring-shaped seal profile of the membrane is provided in the clamping region. In this way, the tightness can be further improved even for a non-uniform distribution of the clamping force.

### BRIEF DESCRIPTION OF THE DRAWINGS

The invention will now be described with reference to the drawings wherein:

FIG. 1 is a side elevation view, in longitudinal section, of a hydraulic spring according to the invention;

FIG. 2 shows the outer ring, in longitudinal section, of the hydraulic spring of FIG. 1;

FIG. 2a is a detail view of the region marked X in FIG. 2;

FIG. 3a is a side elevation view, in longitudinal section, of the cover of the hydraulic spring of FIG. 1;

FIG. 3b is a top plan view of the cover shown in FIG. 3a;

FIG. 4 is a side elevation view, in longitudinal section, of the membrane of the hydraulic spring of FIG. 1; and,

FIG. 4a is a detail view of the region identified by X in FIG. 4.

### DESCRIPTION OF THE PREFERRED EMBODIMENTS OF THE INVENTION

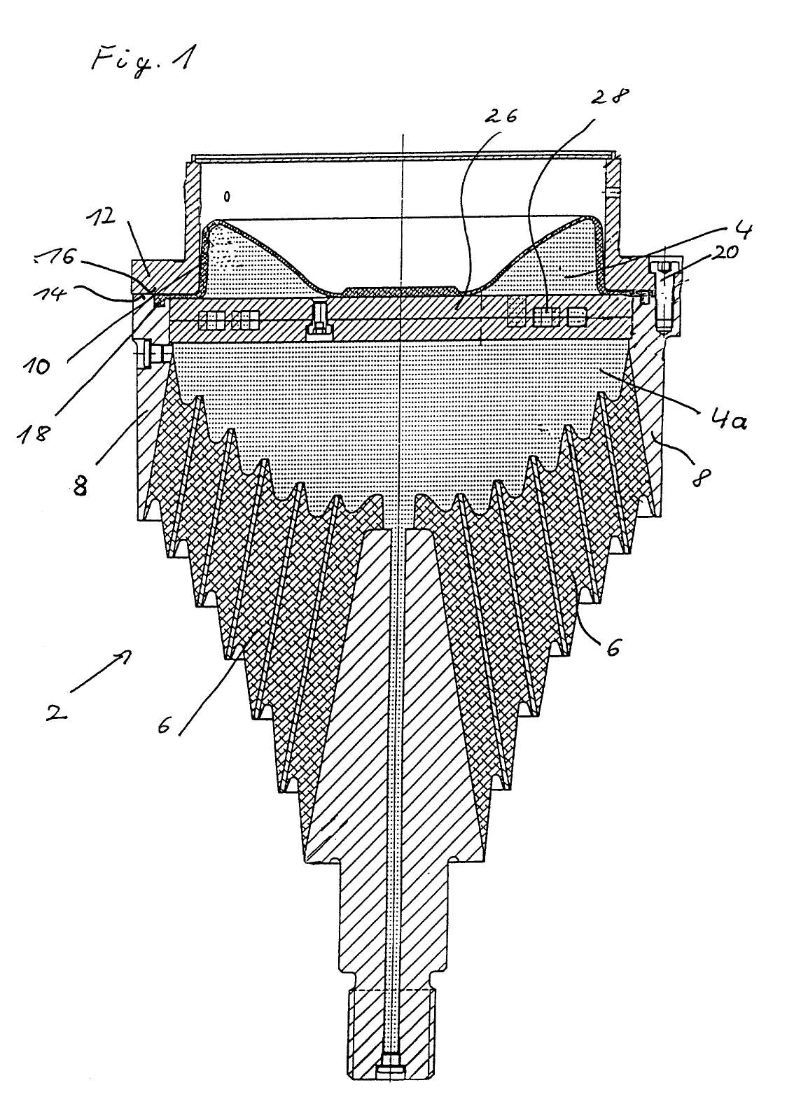

The hydraulic volumes (4a, 4b) of the hydraulic spring 2 shown in FIG. 1 is closed off below by a spring element 6 which is vulcanized into an outer ring 8. Above, the volumes (4a, 4b) are delimited by a membrane 10.

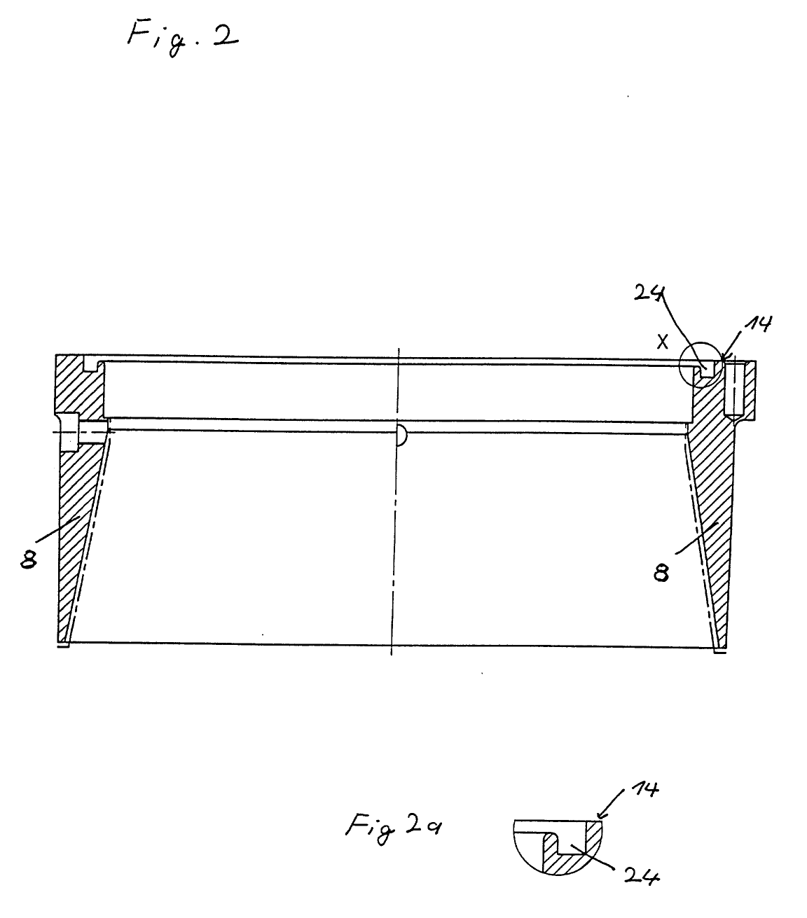

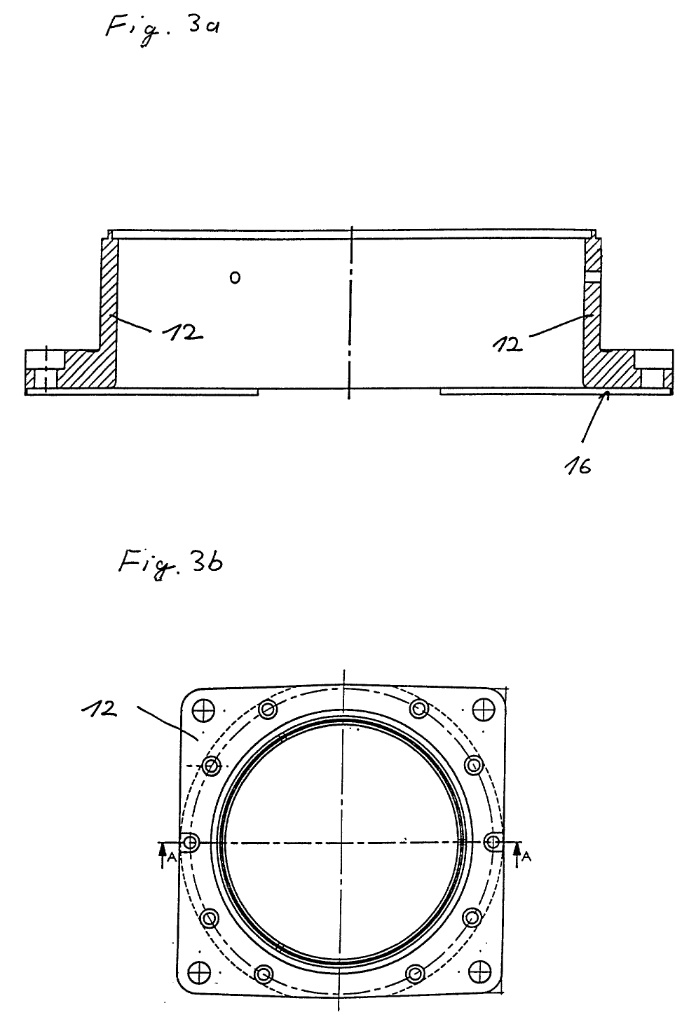

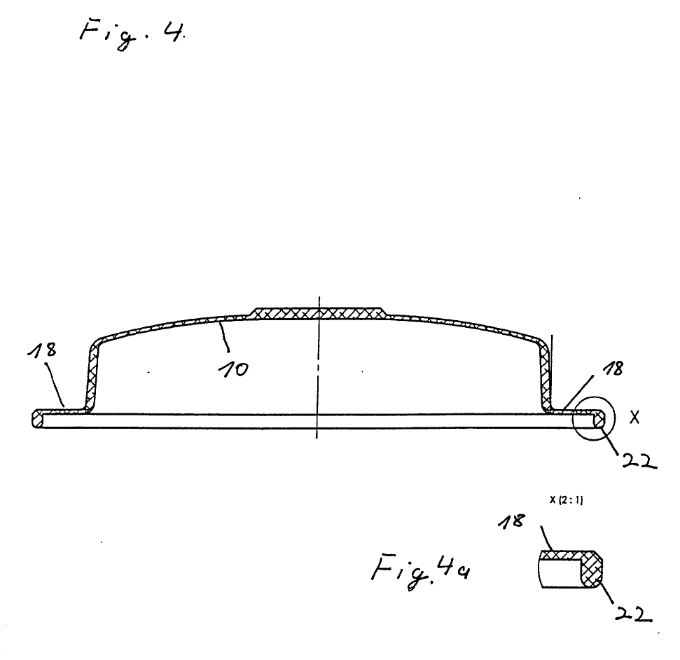

The membrane 10 is pressure tightly attached to the outer ring 8 by means of a cover 12. For this purpose, the outer ring 8 has a planar sealing surface 14 and the cover 12 has a planar sealing surface 16 (FIGS. 2 and 3). The outer edge portion 18 of the membrane 10 (FIG. 4) extends between the planar sealing surfaces (14, 16). Threaded fasteners 20 connect the cover 12 and the outer ring 8 with each other and ensure a pressure-tight attachment of the cover 12 on the outer ring 8.

The membrane edge portion 18 is arranged between the planar sealing surfaces (14, 16) and the attachment thereof is improved in that the membrane 10 has a ring-shaped thickening 22 (FIG. 4, FIG. 4a) on the outer edge portion 18. The thickening 22 engages in a slot 24 (FIG. 2) formed in the sealing surface 14 of the outer ring 8.

The partition plate 26 between the two component volumes 4a and 4b (work chamber 4a, compensating chamber 4b) is provided with compensating channels 28 for the purpose of damping the spring characteristic.

It is understood that the foregoing description is that of the preferred embodiments of the invention and that various changes and modifications may be made thereto without departing from the spirit and scope of the invention as defined in the appended claims.

What is claimed is:

1. A hydraulic spring comprising:
a rubber elastic spring element;
a highly flexible elastic compensating membrane;
said rubber elastic spring element and said compensating membrane conjointly closing off a volume;
a partition wall partitioning said volume into a work chamber delimited by said spring element and a compensating chamber delimited by said elastic compensating membrane;
said chambers being changeable in volume and filled with hydraulic fluid;
said partition wall having at least one connecting channel to permit a flow of said hydraulic fluid between said chambers during the operation of said hydraulic spring;
an outer ring vulcanized to said spring element; and,
a cover disposed atop said compensating membrane for pressure tightly attaching said compensating membrane to said outer ring.

2. The hydraulic spring of claim 1, said outer ring and said cover having respective planar edge portions conjointly defining an interface; said compensating membrane having an outer edge portion being disposed in said interface; and, means for tightly clamping said compensating membrane at said interface between said planar edge portions.

3. The hydraulic spring of claim 2, said outer ring defining a surface at said interface and said outer ring having an annularly-shaped slot formed in said surface thereof; and, said outer edge portion of said compensating ring having a thickening formed thereon of the same radius as said slot; and, said thickening being seated in and filling said slot.

4. The hydraulic spring of claim 1, said outer ring and said cover having respective planar edge portions conjointly defining a sealing interface; said compensating membrane having an outer edge portion being disposed at least partially within said interface; and, said compensating membrane being thickened within and/or outside of said sealing interface.

5. The hydraulic spring of claim 2, wherein said outer edge portion of said compensating membrane has a ring-shaped profile in said interface.
